(19) United States
(12) Patent Application Publication
(10) Pub. No.: US 2025/0378349 A1
(43) Pub. Date: Dec. 11, 2025

(54) LARGE LANGUAGE MODEL COMPRESSION

(71) Applicant: SAMSUNG ELECTRONICS CO., LTD., Suwon-si (KR)

(72) Inventors: Chi-Heng LIN, Mountain View, CA (US); Shanggian GAO, Mountain View, CA (US); Yen-Chang HSU, Mountain View, CA (US); James Seale SMITH, Decatur, CA (US); Abhishek PATEL, Mountain View, CA (US); Shikhar TULI, Sunnyvale, CA (US); Yilin SHEN, Mountain View, CA (US); Hongxia JIN, San Jose, CA (US); Zheng TANG, Foster City, CA (US); Ting HUA, Cupertino, CA (US)

(73) Assignee: SAMSUNG ELECTRONICS CO., LTD., Suwon-si (KR)

(21) Appl. No.: 19/025,332

(22) Filed: Jan. 16, 2025

Related U.S. Application Data
(60) Provisional application No. 63/658,323, filed on Jun. 10, 2024.

(51) Int. Cl. G06N 3/096; G06N 3/045

(52) U.S. Cl. CPC G06N 3/096; G06N 3/045

(57) ABSTRACT

A method performed by an electronic device, includes: receiving a calibration dataset corresponding to a task relevant to a user; providing the calibration dataset as an input to a trained teacher model and an on-device model that are stored in the electronic device; updating the on-device model by, for each layer of the on-device model, determining covariances between the trained teacher model and the on-device model based on: differences between feature maps generated by the trained teacher model and the on-device model, and differences between weights in the trained teacher model and weights in the on-device model; and modifying the weights for the on-device model using matrix decomposition on weight matrices in the trained teacher model based on the determined covariances.

### CROSS-REFERENCE TO RELATED APPLICATION

This application is based on and claims priority under 35 U.S.C. § 119 to U.S. Provisional Patent Application No. 63/658,323, filed on Jun. 10, 2024, in the United States Patent and Trademark Office, the disclosure of which is incorporated by reference herein its entirety.

### BACKGROUND

### 1. Field

The disclosure relates to a system and a method for compressing a large language model (LLM), for example, in the fields of machine learning of artificial intelligence.

### 2. Description of Related Art

Recent advancements in LLMs have led to remarkable breakthroughs in the understanding and generation of natural language. Despite their significant capabilities, these models are computationally and memory-intensive, posing deployment challenges on resource-limited devices. To mitigate these challenges, model compression has emerged as a popular post-training solution, reducing model size and complexity.

There are many well-trained large and public models free for commercial use, and leveraging these models to build high-quality models has become crucial for two main reasons: First, reducing size to save on serving costs or to fit into edge devices. Second, reducing training costs and data requirements. In the related art, techniques to address these challenges fall into two categories: First, (structured) model pruning that involves obtaining smaller models by removing redundant parameters from larger models. Second, knowledge distillation that involves training smaller models to mimic the outputs of larger models.

In the related art, knowledge distillation needs extensive computations for training and needs training data. Structured model Pruning removes weights, which induces large accuracy drops. Thus, there is a challenge for developing a training-free method to build a smaller model with small accuracy drops.

Conventional compression techniques in the related art encompass model distillation, pruning, matrix decomposition, and quantization. Examples of the conventional compression techniques are an original transformer layer of an example LLM (see ‘Approach A’ of FIG. 2 (a)); ‘Singular Value Decomposition’ (SVD) applied to each weight matrix separately, resulting in dual matrices (see ‘Approach B’ of FIG. 2 (b)); an approach C that multiplies each weight matrix by an orthogonal matrix Q, reducing its dimensions while introducing additional adapters (see ‘Approach C’ of FIG. 2 (c)).

The conventional matrix decomposition techniques in the related art, such as SVD (shown in FIG. 2 (b)), typically split each weight matrix W∈ [symbol] into two lower-rank matrices W=AB, requiring a rank less than d/2 to achieve true compression. The approach C (shown in FIG. 2 (c)) multiplies the original matrix with an orthogonal matrix, effectively projecting the inputs into a lower dimensional subspace and reducing the matrix's dimensionality.

An approach D (see ‘approach D’ of FIG. 2 (d)) may partition the transformer block into modules comprised of matrix pairs and reduce the hidden dimensions via reconstructing the module-level output. The approach D may do not require a use of ‘recovery fine-tuning’ (RTF) while avoiding significant drop in accuracy, offsetting parameter savings, and introducing substantial parameter overheads. The approach D may effectively reduce parameters of the LLM without compromising accuracy.

### SUMMARY

The disclosure is directed to a system and a method for dual knowledge distillation of compact model synthesis. Model synthesis is a process of generating a new model without extensive training, while still achieving high accuracy. Model synthesis utilizes an already trained ‘teacher’ model to transfer its knowledge to a new model (‘student’ model,’ which may be smaller than the teacher model), ensuring that the new model retains much of the performance characteristics of the teacher model.

The disclosure is directed to a system and a method for compressing a LLM by grouping matrices of the LLM into modules and applies decomposition to the two matrices jointly, and thus, producing one single dimension-reduced matrix for each matrix.

The disclosure is directed to matrix decomposition techniques that require minimal computing resources and may not involve backward propagation, as seen in RFT or Fisher matrix calculations from Taylor expansion.

According to one aspect of the disclosure, a computer-implemented method performed by an electronic device, includes: receiving, via a user interface of the electronic device, a calibration dataset corresponding to a task relevant to a user; providing the calibration dataset as an input to a trained teacher model and an on-device model that are stored in the electronic device; updating the on-device model by, for each layer of the on-device model; determining covariances between the trained teacher model and the on-device model based on: differences between feature maps generated by the trained teacher model and the on-device model, and differences between weights in the trained teacher model and weights in the on-device model; and modifying the weights for the on-device model using matrix decomposition on weight matrices in the trained teacher model based on the determined covariances; receiving, via the user interface of the electronic device, first input data from the user; providing the first input data to the updated on-device model; generating a first output data by the updated on-device model based on the first input data; and providing the first output data to the user via the user interface of the electronic device.

According to one aspect of the disclosure, a computer-implemented method performed by a server, includes: receiving, via a user interface of the electronic device, a calibration dataset corresponding to a task relevant to a user of an electronic device; providing the calibration dataset as an input to a trained teacher model and an on-device model that are stored in the server; updating the on-device model by, for each layer of the on-device model; determining covariances between the trained teacher model and the on-device model based on: differences between feature maps generated by the trained teacher model and the on-device model, and differences between weights in the trained teacher model and weights in the on-device model; and modifying the weights for the on-device model using matrix decomposition on weight matrices in the trained teacher model based on the determined covariances; and deploying the on-device model to the electronic device, wherein the on-device model deployed on the electronic device is configured to: obtain, via the user interface of the electronic device, first input data from the user; and generate a first output data based on the first input data, and wherein the first output data is provided to the user via the user interface of the electronic device.

According to one aspect of the disclosure, an electronic device includes: a user interface; one or more processors; a memory storing instructions that, when executed by the one or more processors individually or collectively, cause the electronic device to: receive, via the user interface, a calibration dataset corresponding to a task relevant to a user; provide the calibration dataset as an input to a trained teacher model and an on-device model that are stored in the electronic device; update the on-device model by, for each layer of the on-device model; determining covariances between the trained teacher model and the on-device model based on: differences between feature maps generated by the trained teacher model and the on-device model, and differences between weights in the trained teacher model and weights in the on-device model; and modifying the weights for the on-device model using matrix decomposition on weight matrices in the trained teacher model based on the determined covariances; receive, via the user interface, first input data from the user; provide the first input data to the updated on-device model; generate a first output data by the updated on-device model based on the first input data; and provide the first output data to the user via the user interface of the electronic device.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates example components of an electronic device in accordance with an embodiment of the disclosure;

FIG. 2 illustrates conventional compression techniques ((a), (b), and (c)) in related art and an embodiment of a proposed compression technique ((d)) in accordance with an embodiment of the disclosure;

FIG. 3 illustrates an embodiment of dual knowledge distillation model synthesizer in accordance with an embodiment of the disclosure;

FIG. 4 illustrates an embodiment of dual knowledge distillation model synthesizer in accordance with an embodiment of the disclosure;

FIG. 5 illustrates an overall block diagram of dual knowledge distillation model synthesizer in accordance with an embodiment of the disclosure;

FIG. 6 illustrates a set of operations in accordance with an embodiment of the disclosure;

FIG. 7 illustrates a set of operations in accordance with an embodiment of the disclosure;

FIG. 8 illustrates a set of operations in accordance with an embodiment of the disclosure;

FIG. 9 illustrates a set of operations in accordance with an embodiment of the disclosure;

FIG. 10 illustrates a set of operations in accordance with an embodiment of the disclosure;

FIG. 11 illustrates use cases in accordance with an embodiment of the disclosure; and

FIG. 12 illustrates an example block diagram of a server in accordance with an embodiment of the disclosure.

### DETAILED DESCRIPTION

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

The blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

Any of the functions or operations described herein may be processed by one processor or a combination of processors. The one processor or the combination of processors is circuitry performing processing and includes circuitry like an application processor (AP), a communication processor (CP), a graphical processing unit (GPU), a neural processing unit (NPU), a microprocessor unit (MPU), a system on chip (SoC), an IC, or the like.

The disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., via a wire), wirelessly, or via a third element.

A “unit” or a “module” used in the disclosure refer to a hardware component such as a processor or a circuit, and/or a software component executed by a hardware component such as a processor. The “unit” or the “module” may be implemented by a program that is stored in a storage medium which may be addressed, and is executed by a processor. For example, a “unit”, “module” may be implemented by components such as software components, object-oriented software components, class components, and task components, processes, functions, attributes, procedures, sub-routines, segments of a program code, drivers, firmware, a micro code, a circuit, data, a database, data structures, tables, arrays and parameters.

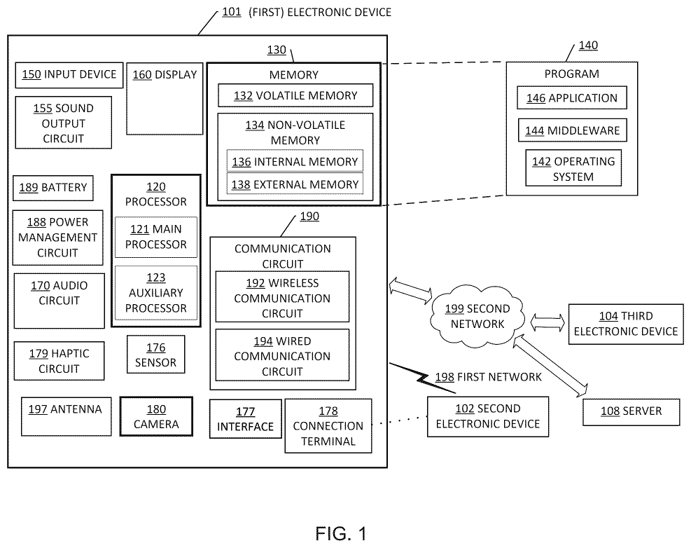

FIG. 1 illustrates example components of the electronic device in accordance with an embodiment of the disclosure.

In FIG. 1, a (first) electronic device 101 may communicate with a second electronic device 102 via a first network 198 (e.g., a short-range wireless communication network), or a third electronic device 104 or a server 108 via a second network 199 (e.g., a long-range wireless communication network). In one embodiment, the (first) electronic device 101 may communicate with the third electronic device 104 via the server 108. Throughout the disclosure, the first electronic device 101 may be referred to as ‘the electronic device 101.’ Hereinafter, components of the electronic device 101 are described. Those components of the electronic device 101 may be also included in the second electronic device 102 or the third electronic device 104. The first electronic device 101, the second electronic device 102, or the third electronic device 104 may be configured to perform methods, steps, or operations described in the disclosure.

In an embodiment, the electronic device 101 may include a processor 120, memory 130, an input device 150, a sound output circuit 155, a display 160, an audio circuit 170, a sensor 176, an interface 177, a connection terminal 178, a haptic circuit 179, a camera 180, a power management circuit 188, a battery 189, a communication circuit 190, or an antenna 197.

In an embodiment, at least one (e.g., the display 160, the sensor 176, or the camera 180) of the components may be omitted from the electronic device 101, or one or more other components may be added in the electronic device 101. In an embodiment, some of the components may be implemented as single integrated circuitry. For example, the sensor 176 (e.g., a fingerprint sensor, an iris sensor, or an illuminance sensor) may be implemented as embedded in the display 160 (e.g., a touch screen). In an embodiment, the electronic device 101 may be a user equipment, a user terminal, a smartphone, a tablet personal computer (PC), a laptop, a PC and/or a server.

In an embodiment, the at least one processor 120 (or the main processor 121 or the auxiliary processor 123) may be implemented in hardware, firmware, or a combination of hardware and software. The at least one processor 120 (or the main processor 121 or the auxiliary processor 123) may include one or more of a central processing unit (CPU), a graphics processing unit (GPU), an accelerated processing unit (APU), a many integrated core (MIC), a field-programmable gate array (FPGA), a digital signal processor (DSP), a neural processing unit (NPU), a hardware accelerator, or a machine learning accelerator. The at least one processor 120 (or the main processor 121 or the auxiliary processor 123) are able to perform control of any one or any combination of the other components of the computing device, and/or perform an operation or data processing relating to communication. The at least one processor 120 (or the main processor 121 or the auxiliary processor 123) execute one or more programs stored in a memory.

The at least one processor 120 (or the main processor 121 or the auxiliary processor 123) may be implemented as one or more multi-core processors that include one or more cores (e.g., homogeneous multi-cores or heterogeneous multi-cores). When a plurality of cores are included in the at least one processor 120 (or the main processor 121 or the auxiliary processor 123), each of the cores includes a cache memory, and a common cache shared by the cores may be included in the at least one processor 120 (or the main processor 121 or the auxiliary processor 123). Each of the cores may independently read and execute program instructions or each of the cores may read and execute one or more portions of program instructions.

In an embodiment, the at least one processor 120 (or the main processor 121 or the auxiliary processor 123) may refer to a system-on-a-chip (SoC) in which one or more cores and other electronic components are integrated, a single core processor, a multicore processor, or a core included in the single core processor or the multicore processor, wherein the core may be implemented as a CPU, a GPU, an APU, an MIC, an FPGA, a DSP, an NPU, a hardware accelerator, or a machine learning accelerator, but the embodiments of the disclosure are not limited thereto.

The processor 120 may execute, for example, software (e.g., a program 140) to control at least one other component (e.g., a hardware or software component) of the electronic device 101 coupled with the processor 120, and may perform various data processing or computation. In one embodiment, as at least part of the data processing or computation, the processor 120 may load a command or data received from another component (e.g., the sensor 176 or the communication circuit 190) in volatile memory 132, process the command or the data stored in the volatile memory 132, and store resulting data in non-volatile memory 134.

In one embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The processor 120 may refer to or correspond to one or more processors. For example, the electronic device 101 may include two or more processors like the processor 120. In an embodiment, the main processor 121 and the auxiliary processor 123 may comprise processing circuitry.

The auxiliary processor 123 may be implemented as separate from, or as part of the main processor 121. The auxiliary processor 123 may control at least some of functions or states related to at least one component (e.g., the display 160, the sensor 176, or the communication circuit 190) among the components of the electronic device 101, instead of the main processor 121 while the main processor 121 is in an inactive (e.g., sleep) state, or together with the main processor 121 while the main processor 121 is in an active state (e.g., executing an application). In one embodiment, the auxiliary processor 123 (e.g., an image signal processor or a communication processor) may be implemented as part of another component (e.g., the camera 180 or the communication circuit 190) functionally related to the auxiliary processor 123.

For example, the processor 120 of the electronic device 101 may invoke at least one of the one or more instructions stored in the memory 130, and execute the at least one of the one or more instructions, with or without using one or more other components under the control of the processor 120. This allows the electronic device 101 to be operated to perform at least one function according to the at least one instruction invoked. The one or more instructions may include a code generated by a compiler or a code executable by an interpreter. The memory 130, which may be a machine-readable storage medium, may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the memory 130 (the storage medium) and where the data is temporarily stored in the memory 130. In an embodiment, the electronic device 101 may comprise one or more processors (e.g., the main processor 121 and the auxiliary processor 123), and the one or more instructions may be executed by the one or more processors individually or collectively, thereby causing the electronic device 101 to perform any combination of one or more operations (or functions, steps) described herein.

In an embodiment, the memory 130 may include a random-access memory (RAM), a read only memory (ROM), and/or another type of dynamic or static storage device (e.g., a flash memory, a magnetic memory, and/or an optical memory) that stores information and/or instructions for use by the processor 120. In an embodiment, the memory 130 may contain information and/or software related to the operation and use of the electronic device 101. For example, the memory 130 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, or another type of non-transitory computer-readable medium, along with a corresponding drive.

The memory 130 may store various data used by at least one component (e.g., the processor 120 or the sensor 176) of the electronic device 101. The various data may include, for example, software (e.g., the program 140) and input data or output data for a command related thereto. The memory 130 may include the volatile memory 132 or the non-volatile memory 134. The non-volatile memory 134 may include the internal memory 136 or external memory 138. The program 140 may be stored in the memory 130 as software, and may include, for example, an operating system (OS) 142, middleware 144, or an application 146.

One or more embodiments of the disclosure may be implemented as software (e.g., the operating system 142, the application 146, the middleware 144) including one or more instructions that are stored in the memory 130 (comprising one or more storage medium) that is readable by the electronic device 101.

In an embodiment, the input device 150 may receive a command or data to be used by another component (e.g., the processor 120) of the electronic device 101, from the outside (e.g., a user, the second electronic device 102, or the third electronic device 104) of the electronic device 101. The input device 150 may include, for example, a microphone, a mouse, a keyboard, a key (e.g., a button), or a digital pen (e.g., a stylus pen).

In an embodiment, the sound output circuit 155 may output sound signals to the outside of the electronic device 101. The sound output circuit 155 may include, for example, a speaker or a receiver. The speaker may be used for general purposes, such as playing multimedia or playing recorded data. The receiver may be used for receiving incoming calls. According to some embodiments, the receiver may be implemented as separate from, or as part of the speaker.

In an embodiment, the display 160 may visually provide information to the outside (e.g., a user) of the electronic device 101. The display 160 may include, for example, a display device, a hologram device, or a projector and control circuitry to control a corresponding one of the display device, hologram device, and projector. According to some embodiments, the display 160 may include a touch sensor adapted to detect a touch, or a pressure sensor adapted to measure the intensity of force incurred by the touch.

In an embodiment, the audio circuit 170 may convert a sound into an electrical signal and vice versa. According to an embodiment, the audio circuit 170 may obtain the sound via the input device 150 or output the sound via the sound output circuit 155 or a headphone of an external electronic device (e.g., the second electronic device 102 or the third electronic device 104) directly (e.g., via a wire) or wirelessly coupled with the electronic device 101.

In an embodiment, a sensor 176 may detect an operational state (e.g., power or temperature) of the electronic device 101 or an environmental state (e.g., a state of a user) external to the electronic device 101, and then generate an electrical signal or data value corresponding to the detected state.

In an embodiment, the interface 177 may support one or more specified protocols to be used for the electronic device 101 to be coupled with the external entity (e.g., the second electronic device 102, the third electronic device 104, or the server 108) directly (e.g., via a wire) or wirelessly. According to an embodiment, the interface 177 may include, for example, a high-definition multimedia interface (HDMI), a universal serial bus (USB) interface, a secure digital (SD) card interface, or an audio interface.

In an embodiment, the connection terminal 178 may include a connector via which the electronic device 101 may be physically connected with the external electronic device (e.g., the second electronic device 102, the third electronic device 104, or the server 108). According to some embodiments, the connection terminal 178 may include, for example, an HDMI connector, a USB connector, an SD card connector, or an audio connector (e.g., a headphone connector).

In an embodiment, the haptic circuit 179 may convert an electrical signal into a mechanical stimulus (e.g., a vibration or a movement) or electrical stimulus which may be recognized by a user via his tactile sensation or kinesthetic sensation. According to an embodiment, the haptic circuit 179 may include, for example, a motor, a piezoelectric element, or an electric stimulator.

In an embodiment, the camera 180 may capture a still image or moving images (or a set or one or more still images, or video data). According to some embodiments, the camera 180 may include one or more lenses, image sensors, ISPs, or flashes.

In an embodiment, the power management circuit 188 may manage power supplied to the electronic device 101. According to some embodiments, the power management circuit 188 may be implemented as at least part of, for example, a power management integrated circuit (PMIC).

In an embodiment, the battery 189 may supply power to at least one component of the electronic device 101. According to some embodiments, the battery 189 may include, for example, a primary cell which is not rechargeable, a secondary cell which is rechargeable, or a fuel cell.

In an embodiment, the communication circuit 190 may include a transceiver-like component (e.g., a transceiver and/or a separate receiver and transmitter) that enables the electronic device 101 to communicate with other devices (e.g., the second electronic device 102, the third electronic device 104, or the server 108), such as via a wired connection, a wireless connection, or a combination of wired and wireless connections. The communication circuit 190 may permit the electronic device 101 to receive information from another device and/or provide information to another device. For example, the communication circuit 190 may include an Ethernet interface, an optical interface, a coaxial interface, an infrared interface, a radio frequency (RF) interface, a universal serial bus (USB) interface, a Wi-Fi interface, a cellular network interface, or the like. In an embodiment, the communication circuit 190 may be a communication ‘interface’ used to connect the electronic device 101 with the other devices.

In an embodiment, the communication circuit 190 may include one or more communication processors (CPs) that are operable independently from the processor 120 (e.g., an application processor) and supports a direct (e.g., wired) communication or a wireless communication. According to an embodiment, the communication circuit 190 may include a wireless communication circuit 192 (e.g., a cellular communication module, a short-range wireless communication module, or a global navigation satellite system (GNSS) communication module) or a wired communication circuit 194 (e.g., a local area network (LAN) communication module or a power line communication (PLC) module).

A corresponding one of these communication modules may communicate with the external electronic device via the first network 198 (e.g., a short-range communication network, such as Bluetooth™, Wi-Fi direct, or IR data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication circuit 192 may identify and authenticate the electronic device 101 in a communication network, such as the first network 198 or the second network 199, using subscriber information (e.g., international mobile subscriber identity (IMSI)).

The antenna 197 may transmit or receive a signal or power to or from the outside (e.g., an external electronic device) of the electronic device 101. According to an embodiment, the antenna 197 may include an antenna including a radiating element composed of a conductive material or a conductive pattern formed in or on a substrate (e.g., a printed circuit board (PCB)). According to an embodiment, the antenna 197 may include a plurality of antennas (e.g., array antennas).

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

In an embodiment, a set of components (e.g., one or more components) of the electronic device 101 may perform one or more functions described as being performed by another set of components of the electronic device 101.

An embodiment of a transformer architecture in the related art is described below.

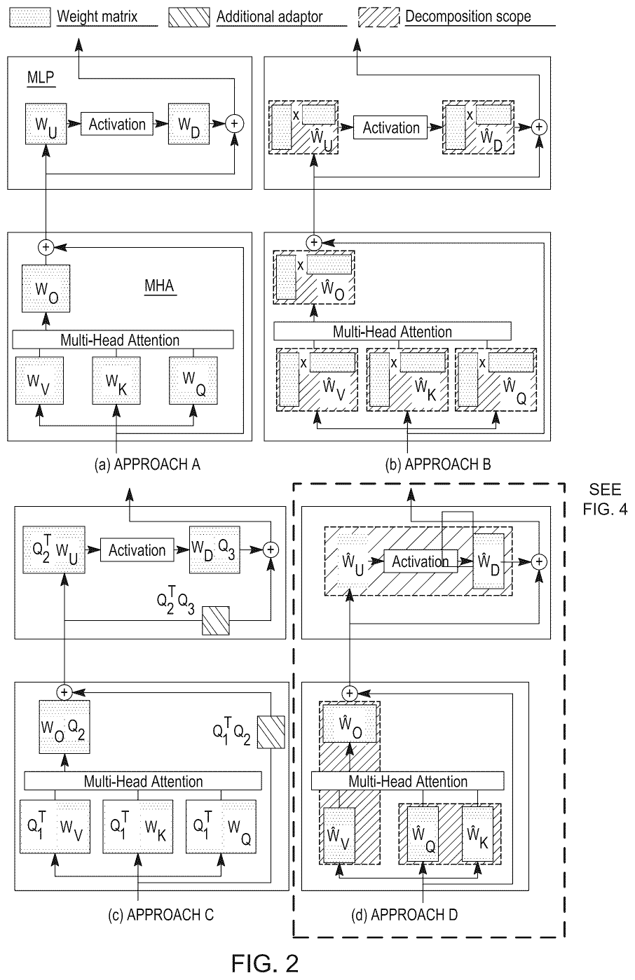

In the related art, the transformer architecture includes multiple decoder layers. A typical layer, such as in LLM of FIG. 2 (a), includes two blocks: the Multi-Head Attention (MHA) and the Multi-Layer Perceptron (MLP), as shown in FIG. 2 (a). T, dₕ, dᵢₙₜ, and H denote the sequence length, hidden dimension, intermediate dimension, and the number of attention heads, respectively. The formulation of these blocks is as follows:

$$( MLP block ) {f}_{MLP} ( X ) = {\underbrace{{σ}_{s} ( {XW}_{U} ) {W}_{D}}}_{Type - I} \qquad ( 1 )$$

$$( MHA block ) {f}_{MHA} ( X ) = {\sum }_{i = 1}^{H} Softmax {\underbrace{( {σ}_{r} ( {XW}_{Q , i} ) {σ}_{r}^{T} ( {XW}_{K , i} ) )}}_{Type - II} {\underbrace{{XW}_{V , i} {W}_{O , i}}}_{Type - III} \qquad ( 2 )$$

where X ∈ [symbol] is the input matrix,

$${W}_{Q , i} , {W}_{K , i} , {W}_{V , i} ∈ {ℝ}^{{d}_{h} \times \frac{{d}_{h}}{H}} , {W}_{O , i} ∈ {ℝ}^{\frac{{d}_{h}}{H} \times {d}_{h}}$$

are the head-specific query, key, value, and output matrices. The matrices W_{U}∈ [symbol] and W_{D}∈ [symbol] denote up and down projections, respectively, with σᵣ and σₛ denoting positional embedding and nonlinear activation functions. MLP formulation encompasses the gated MLP: the up matrix is defined by the concatenations of the gated and up matrix

$${W}_{U} = {[ {W}_{u}^{T} , {W}_{g}^{T} ]}^{T} ,$$

and the nonlinear function is defined by σₛ (XW_{U}):=XWᵤ⊙σ_{g}(XW_{g}), where σ_{g} is the gate function.

In the expressions of the above equation (1) and equation (2), the blocks may be divided into three types of functional modules, each associated with a pair of matrices:

$$\begin{matrix}\text{Type-I:} & f ( X ; {W}_{U} , {W}_{D} ) = {σ}_{s} ( {XW}_{U} ) {W}_{D} , \\ \text{Type-II:} & f ( X ; {W}_{K}^{i} , {W}_{Q}^{i} ) = {σ}_{r} ( {XW}_{Q}^{i} ) {{σ}_{r} ( {XW}_{K}^{i} )}^{T} , \\ \text{Type-III:} & f ( X ; {W}_{V}^{i} , {W}_{O}^{i} ) = {XW}_{V}^{i} {W}_{O}^{i} ,\end{matrix}$$

Here, X denotes the input and the variable after “;” denotes the associated matrices. Based on their levels of nonlinearity, these modules are categorized into Type-I, Type-II, and Type-III, and different matrix decomposition methods are applied for compression according to optimization tractability.

Low-Rank Matrix Approximation in the related art is described below.

The goal of a traditional low-rank approximation method is to approximate a matrix W∈ [symbol] with two low-rank matrices A∈ [symbol] and B∈ [symbol] .

Definition 1. For a low-rank approximation method [symbol] that decomposes a matrix W into A and B, the approximation matrix is [symbol] =AB and the error to W is [symbol] (W)=∥W− [symbol] ∥F.

Three approximation methods, which facilitate the compression algorithms, are described below.

### I. Nyström Approximation.

Nyström approximation is a technique used to approximate large matrices, particularly kernel matrices, with smaller, low-rank matrices. This approximation is valuable, as the approximation can significantly reduce computational costs and memory usage.

If W is a positive semidefinite matrix, let Sₖ be a k-column selection matrix where each column has a single non-zero element indicating the selected index.

$${W}_{Nys} = AB , where A = {S}_{k} and B = {( {S}_{k}^{T} {WS}_{k} )}^{†} {S}_{k}^{T} W \qquad ( 3 )$$

### II. CR Decomposition.

CR decomposition is a matrix factorization technique that expresses any matrix A as the product of two matrices: C and R.

Assuming W may be factored as W₁W₂, let Sₖ be a k-column selection matrix, the CR approximation of W is

$${W}_{CR} = AB , where A = {W}_{1} {S}_{k} and B = {S}_{k}^{T} {W}_{2} \qquad ( 4 )$$

### III. Singular Value Decomposition (SVD).

SVD is a matrix factorization technique that decomposes a matrix into the product of three simpler matrices. SVD is renowned for yielding the minimum approximation error when measured in the Frobenius norm. SVD decomposes W into:

$${W}_{SVD} = AB , where A = {U}_{k} and B = {\sum }_{k} {V}_{k}^{T} \qquad ( 5 )$$

where Uₖ, Vₖ are matrices containing the top-k left and right eigenvectors, respectively, and Σₖ is the diagonal matrix consisting of the top-k eigenvalues of WW^{T}.

Unlike the above described conventional low-rank approximation methods, dual knowledge distillation model synthesizer of this disclosure proposes a module-level optimization. Dual knowledge distillation model synthesizer jointly compresses two matrices within each of three defined functional modules, rather than compressing each matrix independently.

The matrix decomposition technique using the dual knowledge distillation model synthesizer according to an embodiment of the disclosure may be referred as ‘Matrix Decomposition-Based Methods for Transformer Compression’, which applies matrix decompositions to multiple matrices jointly, avoiding the dual-matrix structure or extra adapters used in the related art. Dual knowledge distillation model synthesizer is also described in “MoDeGPT: Modular Decomposition for Large Language Model Compression” published at NeurIPS 2024.

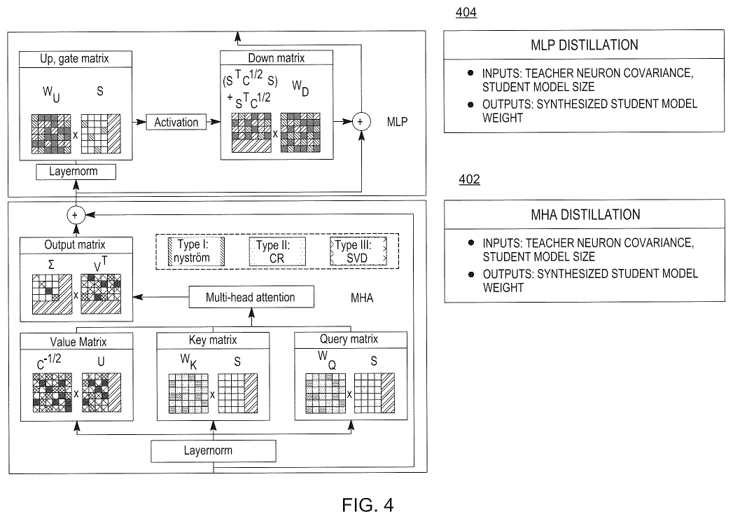

As illustrated in FIG. 2 (d), dual knowledge distillation model synthesizer according to an embodiment of the disclosure elevates the matrix decomposition approach to a modular level. The dual knowledge distillation model synthesizer groups weight matrices into modules and applies matrix decomposition jointly within each module. Unlike the conventional compression techniques (such as the approach C, which is shown in FIG. 2 (c)), dual knowledge distillation model synthesizer decreases the intermediate dimensions within each module rather than between blocks. This crucial difference eliminates the need for the adapters while still enabling dimension reduction in the compressed matrix. The dual knowledge distillation model synthesizer establishes a comprehensive framework that maps each module's compression challenges to one of three matrix approximation techniques: CR decomposition, singular value decomposition (SVD), and Nystrom approximation. These methods enable the dual knowledge distillation model synthesizer to efficiently compress matrices. Details of the dual knowledge distillation model synthesizer in FIG. 2 (d) are illustrated in FIG. 4.

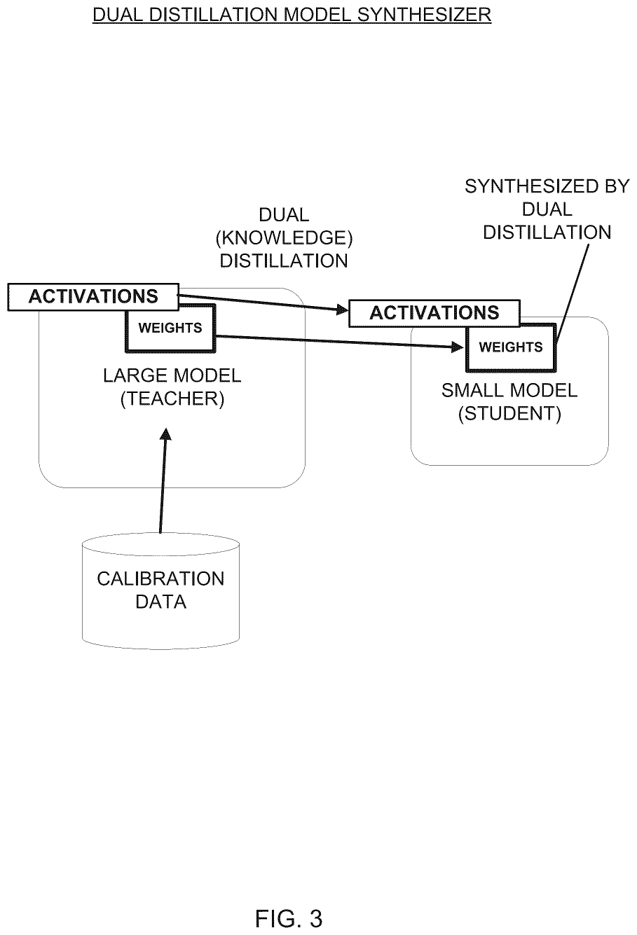

FIG. 3 illustrates an embodiment of the dual knowledge distillation model synthesizer in accordance with an embodiment of the disclosure. The dual knowledge distillation model synthesizer illustrated in FIG. 3 is a framework for model synthesis through dual knowledge distillation. The dual knowledge distillation model synthesizer is a set of operations of “model synthesis” as the dual knowledge distillation model synthesizer effectively generates a small model (e.g. ‘SMALL MODEL (STUDENT)’ of FIG. 3) based on a large model (e.g. ‘LARGE MODEL (TEACHER)’ of FIG. 3) using dual (knowledge) distillation during calibration. Dual knowledge distillation model synthesizer stands out from the methods in the related art (which are shown in FIGS. 2 (a), (b), and (c),) by combining two aspects in a unified framework: First, distillation of neuron activation patterns. Unlike the methods in the related art, which only distill model weights, The dual knowledge distillation model synthesizer also distills neuron activation patterns (e.g., ‘ACTIVATIONS’ illustrated in FIG. 3). Second, calibration instead of training. The dual knowledge distillation model synthesizer may not require extensive training. Dual knowledge distillation model synthesizer only needs calibration from a small dataset (e.g., ‘CALIBRATION DATA’ of FIG. 3), substantially reducing the training cost.

FIG. 4 illustrates an embodiment of the dual knowledge distillation model synthesizer in accordance with an embodiment of the disclosure. The dual knowledge distillation model synthesizer divides a transformer layer into three distinct modules (namely, ‘value & output matrices’, ‘key and query matrices’, and ‘MLP module’) each optimizing two matrices using a specific low-rank approximation method. For example, for each module, a tailored low-rank approximation is applied to compress the two matrices of the dual knowledge distillation model synthesizer. The twill hatch pattern represents dimension reductions. As shown in FIG. 4, the dual knowledge distillation model synthesizer may include at least two operations: MHA distillation 402 and MLP distillation 404, which respectively receive, as input, teacher neuron covariance and student model size, and generate, as output, synthesized student model weights.

An example objective for the dual knowledge distillation model synthesizer in accordance with an embodiment of the disclosure is described below. Then, in accordance with some embodiments of the disclosure, applications of low-rank approximations for effective compression within each module are described. Finally, in accordance with an embodiment of the disclosure, a method for assigning sparsity levels across different layers (which requires only one forward pass of the model on the calibration data) is described.

Modular reconstruction objective of the disclosure is described below.

In accordance with an embodiment of the disclosure, one objective of the dual knowledge distillation model synthesizer is to jointly optimize two matrices, which is termed as “modular decomposition,” within the module types in the previous section, minimizing the modular reconstruction error V:

$${V}^{*} {=}^{△} {min}_{{\hat{W}}_{1} {\hat{W}}_{2}} {\sum }_{i = 1}^{N} {‖ f ( {X}_{i} ; {W}_{1} , {W}_{2} ) - f ( {X}_{i} ; {\hat{W}}_{1} , {\hat{W}}_{2} ) ‖}^{2} \\ such that \\ ( {\hat{W}}_{1} , {\hat{W}}_{2} ) ∈ 𝒞 \qquad ( 6 )$$

Here, Xᵢ ∈ [symbol] are samples in the calibration set, and [symbol] represents the constrained search space for compressed matrices that mandates specific structures or dimensions. One motivation of this disclosure's example objective is that the dual knowledge distillation model synthesizer expands the search space to include dimension-reduced matrices, thereby increasing optimization flexibility and enhancing inference speedup in the compressed model. This contrasts with independent optimization, where each matrix must adhere to the original dimensions. However, objectives of the disclosure are not limited the above-described objective.

Algorithms in accordance with some embodiments of the disclosure are described below.

A compression algorithm for each module in accordance with an embodiment of the disclosure is described below and is linked to the matrix approximation in accordance with an embodiment of the disclosure described above.

Type-I Compression in accordance with an embodiment of the disclosure is described below.

First, the MLP module in accordance with an embodiment of the disclosure is described. As detailed, the matrices to be approximate are W_{U}, W_{D}. Since W_{U} is inside a nonlinear function σₛ, the search space for its approximation is constrained to be a matrix multiplication W_{U}Sₖ for tractability, where Sₖ is the k-column selection matrix. For W_{D}, it is ensured that its dimensions are compatible with W_{U}Sₖ. The first theorem in accordance with an embodiment of the disclosure suggests that under the search spaces, the optimization in equation (6) is closely related to the Nyström approximation of the activation covariance.

Theorem 1 (MLP compression may be solved by Nyström approximation).

Let Ŵ_{U} be searched over the matrix multiplication form W_{U}Sₖ, where Sₖ is a k-column selection matrix, and let Ŵ_{D} be searched over [symbol] . Then, the optimal Ŵ_{D} may be expressed as

$${( {S}_{k}^{T} {C}_{σ}^{\frac{1}{2}} {S}_{k} )}^{†} {S}_{k}^{T} {C}_{σ}^{\frac{1}{2}} {W}_{D} ,$$

and Type-I reconstruction error in equation (6) satisfies:

$${V}_{1} \leq {‖ {W}_{D} ‖}_{2}^{2} {ε}_{Nys}^{2} ( {C}_{σ}^{\frac{1}{2}} ) \qquad ( 7 )$$

where

$${ε}_{Nys}^{2} ( {C}_{σ}^{\frac{1}{2}} )$$

denotes the error to the activation

$${C}_{σ} {=}^{△} {\sum }_{i = 1}^{N} {σ ( {X}_{i} {W}_{U} )}^{T} σ ( {X}_{i} {W}_{U} )$$

of Nyström method in Definition 1 (as stated above, “For a low-rank approximation method [symbol] that decomposes a matrix W into A and B, the approximation matrix is [symbol] =AB and the error to W is [symbol] (W)=∥W− [symbol] ∥_{F}”), using the same Sₖ in the compression of the up matrix W̅_{U}.

Theorem 1 in accordance with an embodiment of the disclosure demonstrates that an effective compression strategy may be achieved by designing a good Nyström matrix approximation. Consequently, Algorithm 1 in accordance with an embodiment of the present is proposed as shown below:

Algorithm 1 Type-I compression for MLP by Nyström approximation.

| 1: | Input: concatenated up and gated matrices W_{U} ∈ [symbol] , down matrix W_{D} ∈ [symbol] , activation | |
|---|---|---|
| | $covariance {C}_{σ} = {\sum }_{i = 1}^{N} {σ ( {X}_{i} {W}_{U} )}^{⊤} σ ( {X}_{i} {W}_{U} ) , rank k = ⌈ ( 1 - sparsity ) {d}_{int} ⌉ , ridge intensity λ$ | |
| 2: | ${s}_{i} ← {⌊ {{C}_{σ}^{\frac{1}{2}} ( {C}_{σ}^{\frac{1}{2}} + λ I )}^{- 1} ⌋}_{ii} for i = 1 , … , {d}_{im}$ | [symbol] Calculate the ridge leverage score |

| | |
|---|---|
| 3: | Let Sₖ ∈ [symbol] be the matrix that selects the top k columns based on sᵢ scores. |
| 4: | $return ( {W}_{U} , {W}_{D} ) ← ( {W}_{U} {S}_{k} , {( {S}_{k}^{⊤} {C}_{σ}^{\frac{1}{2}} {S}_{k} )}^{†} {S}_{k}^{⊤} {C}_{σ}^{\frac{1}{2}} {W}_{D} )$ |

Proposition 1 in accordance with an embodiment of the disclosure shows that the module reconstruction error may be controlled by Algorithm 1:

Proposition 1. Suppose that the rank k and the scores sᵢ in Algorithm 1 in accordance with an embodiment of the disclosure are chosen such that there exists an error ε>0 satisfying

$$ε \geq {\sum }_{i = k + 1}^{{d}_{i n t}} {s}_{i} ,$$

then the type-I modular reconstruction error in equation (6) is bounded by

$${V}_{I} \leq {‖ {W}_{D} ‖}_{2}^{2} \frac{{ε}^{2} {d}_{i n t}^{2}}{{{k}^{2} ( 1 - ε )}^{2}} {\sum }_{i = k + 1}^{{d}_{i n t}} {σ}_{i} ( {C}_{σ} ) ,$$

where dᵢₙₜ and σᵢ denote the intermediate dimension (i.e., the input dimension of W_{D}) and singular values, respectively.

Type-II Compression in accordance with an embodiment of the disclosure is described below.

Next, Type-II module in accordance with an embodiment of the disclosure includes to the key-query interactions within the multi-head attention mechanisms. Compression will be applied to each head independently. Given that both W_{Q} and W_{K} are embedded with nonlinear functions, a simple optimization is opted for. Both matrices are approximated using the same matrix multiplication: Ŵ_{Q}=W_{Q}Sₖ and W_{K}=W_{K}Sₖ, where Sₖ is a k-column selection matrix. Within this constrained search space, the modular reconstruction problem is connected with the CR decomposition of the product of key and query covariances, as elaborated in the following theorem in accordance with an embodiment of the disclosure.

Theorem 2 (Key-Query compression may be solved by CR approximation). Let the compressed Ŵ_{Q}, Ŵ_{K} to be the form of W_{Q}Sₖ, W_{K}Sₖ, then Type-II reconstruction error in equation 6 has

$${V}_{II} \leq {ε}_{C R}^{2} ( {C}_{K}^{\frac{1}{2}} {C}_{Q}^{\frac{1}{2}} ) \qquad ( 8 )$$

where ε_{CR} denotes the approximation error to

$${C}_{K}^{\frac{1}{2}} {C}_{Q}^{\frac{1}{2}}$$

of the CR decomposition in Definition 1, using the same Sₖ. Here, the matrices

$${C}_{Q}^{\frac{1}{2}} {=}^{Δ} {σ ( {X}_{i} {W}_{Q} )}^{⊤} σ ( {X}_{i} {W}_{Q} ) and {C}_{K}^{\frac{1}{2}} {=}^{Δ} {\sum }_{i = 1}^{N} {σ ( {X}_{i} {W}_{K} )}^{⊤} σ ( {X}_{i} {W}_{K} )$$

denote the covariances of query and key states, respectively.

The theorem discussed above demonstrates that effective compression for Type-II module may be achieved through a carefully designed CR approximation. Consequently, Algorithm 2 in accordance with an embodiment of the disclosure is introduced as shown below:

Algorithm 2 Type-Il compression for key-query matrices by CR decomposition.

| 1: | Input: query matrix W_{Q,j} ∈ [symbol] , key matrix W_{K,j} ∈ [symbol] , query state convariance C_{Q,j} = | |
|---|---|---|
| | ${\sum }_{i = 1}^{N} {{σ}_{r} ( {X}_{i} {W}_{Q , j} )}^{⊤} {σ}_{r} ( {X}_{i} {W}_{Q , j} ) , key state covariance {C}_{K , j} = {\sum }_{i = 1}^{N} {σ ( {X}_{i} {W}_{K , j} )}^{⊤} σ ( {X}_{i} {W}_{K , J} ) , for$ | |
| | head j = 1, ... , H, rank k = ┌(1 − sparsity)dₕ/H┐ | |
| 2: | for j = 1, ... , H do | [symbol] Apply compression to each head independently |
| 3: | ${s}_{i} ← ‖ {C}_{Q , j}^{\frac{1}{2}} [ : , i ] ‖ ‖ {C}_{K , j}^{\frac{1}{2}} [ : , i ] ‖$ | [symbol] Calculate the norm score |
| 4: | Let Sₖ ∈ [symbol] be the matrix that selects the top k columns based on sᵢ scores. | |
| 5: | (W_{Q,j}, W_{K,j}) ← (W_{Q,j}Sₖ,W_{K,j}Sₖ) | |
| 6: | return (W_{Q}, W_{K}) ← ([W_{Q,1}, ... , W_{Q,H}], [W_{K,1}, ... ,W_{K,H}]) | [symbol] Concatenate the heads |

In an embodiment, Algorithm 2 comes with the following reconstruction guarantees:

Proposition 2. If Algorithm 2 is adopted, then Type-II modular reconstruction error is bounded by

$${V}_{II} \leq {( \frac{{d}_{h} - k}{{d}_{h}} )}^{2} ( {\sum }_{i = 1}^{{d}_{h}} {σ}_{i} ( {C}_{K} ) ) ( {\sum }_{i = 1}^{{d}_{h}} {σ}_{i} ( {C}_{Q} ) ) ,$$

where σᵢ denotes the singular values.

Type-III Compression in accordance with an embodiment of the disclosure is described below.

The Type-III module involves the value-output matrices. For clarity and simplicity, the head dependency is omitted. The module operates through linear transformations defined as f(X)=XŴ_{V}W̅_{O}, where a goal of the module in accordance with an embodiment of the disclosure is to find Ŵ_{V}∈ [symbol] , Ŵ_{O}∈ [symbol] such that Ŵ_{V}Ŵ_{O}≈W_{V}W_{O}. The subsequent theorem in accordance with an embodiment of the disclosure reveals that the reconstruction may be solved optimally by applying the well-known SVD.

Theorem 3 (Value-Output compression may be solved by SVD) is described below.

If Ŵ_{V} and Ŵ_{O} are searched over [symbol] and [symbol] , respectively, the optimum in Equation (6) is

$${W}_{V} = {C}^{- \frac{1}{2}} {U}_{k}$$

and W_{O}=ΣEV^{T}. Here, UΣV^{T} is the SVD of

$${C}^{\frac{1}{2}} {W}_{V} {W}_{O} ,$$

and

$$C {=}^{Δ} {\sum }_{i = 1}^{N} {X}_{i}^{⊤} {X}_{i}$$

is the input covariance. The Type-III reconstruction error in equation (6) is exactly the error

$${C}^{\frac{1}{2}} {W}_{V} {W}_{O} ,$$

### of SVD in Definition 1:

$${V}_{III} = {ℰ}_{SVD}^{2} ( {C}^{\frac{1}{2}} {W}_{V} {W}_{O} ) \qquad ( 9 )$$

Building on the established equivalence to SVD in Theorem 3, Algorithm 3 in accordance with an embodiment of the disclosure is introduced as shown below:

Algorithm 3 Type-III compression for value-output matrices by SVD.

| 1: | Input: value matricex W_{V,j} ∈ [symbol] , output matrix W_{O,j} ∈ [symbol] for head j = 1, ... , H, | |
|---|---|---|
| | $input covariance C = {\sum }_{i = 1}^{N} {X}_{i}^{⊤} {X}_{i} , rank k = ⌈ ( 1 - sparsity ) {d}_{h} / H ⌉$ | |
| 2: | for j = 1, . . . , H do | [symbol] Apply compression to each head independently |
| 3: | $( U , \sum , {V}^{⊤} ) ← SVD ( {C}^{\frac{1}{2}} {W}_{V , j} )$ | $⊳ Efficient SVD of {C}^{\frac{1}{2}} {W}_{V , j} {W}_{O , j} ( 1 / 2 )$ |
| 4: | (U′, Σ′, V′^{T}) ← SVD(ΣV^{T}W_{O,j}) | $⊳ Efficient SVD of {C}^{\frac{1}{2}} {W}_{V , j} {W}_{O , j} ( 2 / 2 )$ |
| 5: | $( {W}_{V , j} {W}_{O , j} ) ← ( {C}^{- \frac{1}{2}} {UU}^{′} [ : , : k ] , {\sum }^{′} [ : k , : k ] {{V}^{′} [ : , : k ]}^{⊤} )$ | |
| 6: | return (W_{V}, W_{O}) ← ([W_{V,1} , ... , W_{V,H}], [W_{O,1} , ... , W_{O,H}]) | [symbol] Concatenate the heads |

In an embodiment, Algorithm 3 may guarantee the following:

Proposition 3. Denote σᵢ as the singular values, Algorithm 3 yields the optimal Type-III modular reconstruction error

$${V}_{III} = {\sum }_{i = k + 1}^{{d}_{h}} {σ}_{i}^{2} ( {C}^{\frac{1}{2}} {W}_{V} {W}_{O} ) .$$

Global Sparsity Allocation in accordance with an embodiment of the disclosure is described below.

While the dual knowledge distillation model synthesizer modules in accordance with an embodiment of the disclosure are optimized locally, a global optimization strategy in accordance with an embodiment of the disclosure that translates layer importance scores into sparsity allocations across layers may be provided. This strategy seeks to maximize the sum of importance scores, weighted by the parameters retained in each layer. In an embodiment, to avoid the negative effects of excessive sparsity, entropic regularization for smoothing may be incorporated. The formulation of this constrained optimization problem is as follows:

$${max}_{{ϕ}_{1 : L}} {\sum }_{i = 1}^{L} {s}_{i} ( 1 - {ϕ}_{i} ) + ε H ( {ϕ}_{i} ) such that \frac{1}{L} {\sum }_{i = 1}^{L} {ϕ}_{i} = {ϕ}_{avg} , 0 \leq {ϕ}_{i} \leq 1 \qquad ( 10 )$$

where ϕᵢ and sᵢ represent the sparsity and importance score of layer i, respectively, and ϕ_{avg} denotes the overall target sparsity. For sufficiently large E, the following theorem in accordance with an embodiment of the disclosure demonstrates that the optimal layer sparsity distribution may be easily computed as:

$$ϕ = L {ϕ}_{avg} \times Softmax ( - s / ε ) \qquad ( 11 )$$

Theorem 4. For sufficient large ¿, equation (11) is the optimal sparsity to equation (10).

In implementations of dual knowledge distillation model synthesizer in accordance with an embodiment of the disclosure, the Block Influence (BI) score is adopted. The BI score is the negative correlation between a layer's input and output defined by:

$$s = 1 - 𝔼 {x}_{in}^{⊤} {x}_{out} / {‖ {x}_{in} ‖}_{2} {‖ {x}_{out} ‖}_{2} .$$

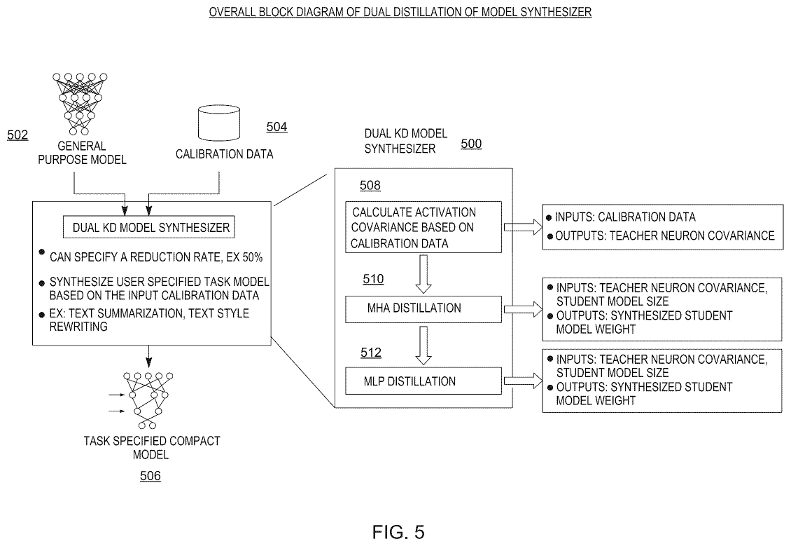

FIG. 5 illustrates an overall block diagram of dual knowledge distillation (KD) model synthesizer 500 in accordance with an embodiment of the disclosure.

The dual KD model synthesizer 500 can specify a reduction rate (for example, 50%) for a general purpose model 502 (e.g., teacher model). The dual KD model synthesizer 500 may synthesize user specified task model based on the input calibration data 504. Non limiting examples of the input calibration data 504 are text summarization and text style rewriting. An output of the dual KD model synthesizer 500 is a task specific compact model 506 (e.g., student model).

The dual KD model synthesizer 500 may include three operations. First, at operation 508, based on the input calibration data 504, the dual KD model synthesizer 500 calculates and outputs activation covariance (e.g., teacher neuron covariance).

At operation 510, the dual KD model synthesizer 500 performs MHA distillation. For example, based on the teacher neuron covariance, the dual KD model synthesizer 500 outputs synthesized student model weights.

At operation 512, the dual KD model synthesizer 500 performs MLP distillation. For example, based on the teacher neuron covariance and the student model size, the dual KD model synthesizer 500 outputs synthesized student model weights.

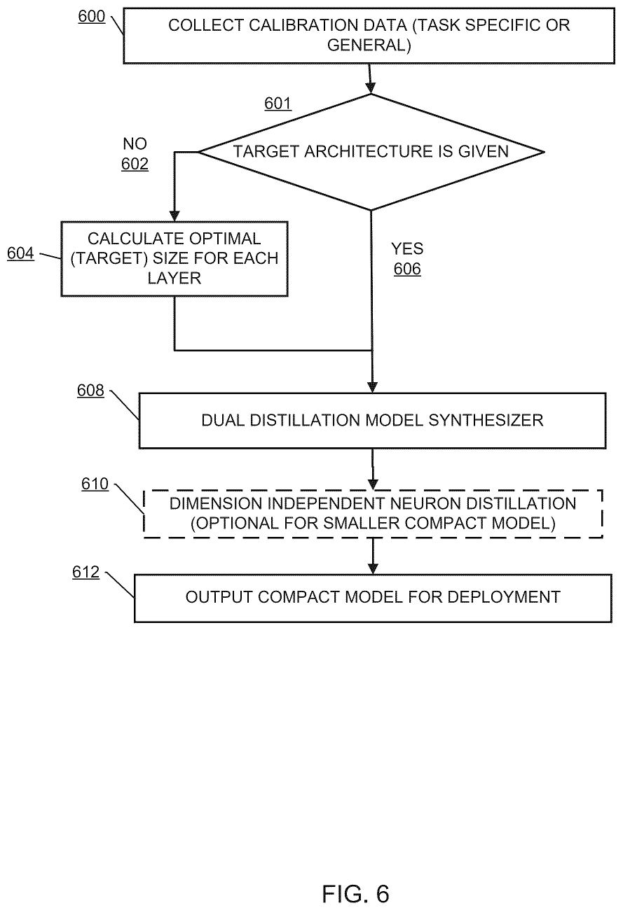

FIG. 6 illustrates a set of operations in accordance with an embodiment of the disclosure. At operation 600, the electronic device 101 collects calibration data (task specific or general, for example, 504) for a general purpose model (e.g., 502 in FIG. 5). In an embodiment, the calibration data may be collected from at least one of the second electronic device 102, the third electronic device 104, or the server 108.

At operation 601, the electronic device 101 determines (or identifies) whether a target architecture is given (or determined). If ‘No’ (602), the electronic device 101 calculates an optimal (target) size for each layer of the target architecture (operation 604). If ‘Yes’ (606), the electronic device 101 operates the dual KD model synthesizer 500 (Dual knowledge distillation model synthesizer) to get a task specified compact model (e.g., 506 in FIG. 5) (operation 608).

At operation 610, optionally, for a smaller compact model, the electronic device 101 may perform a dimension independent neuron distillation of the task specified compact model acquired from operation 608. At operation 612, the task specified compact model (from operation 608) or the smaller compact model (from operation 610) is output for deployment, for example, on the electronic device 101, the second electronic device 102, the third electronic device 104, or the server 108.

In an embodiment, descriptions of the data flow diagram described above with reference to FIG. 6 may be omitted for the sake of brevity. In an embodiment, descriptions of the data flow diagram described above with reference to FIG. 6 may be used to implement at least a portion of at least one of the example application of the first electronic device 101 and may include additional feature. In an embodiment, any combination of operations in FIG. 6 may be implemented in computer codes or instructions stored in the memory 130 and may be performed by the processor 120 of the electronic device 101 (shown in FIG. 1).

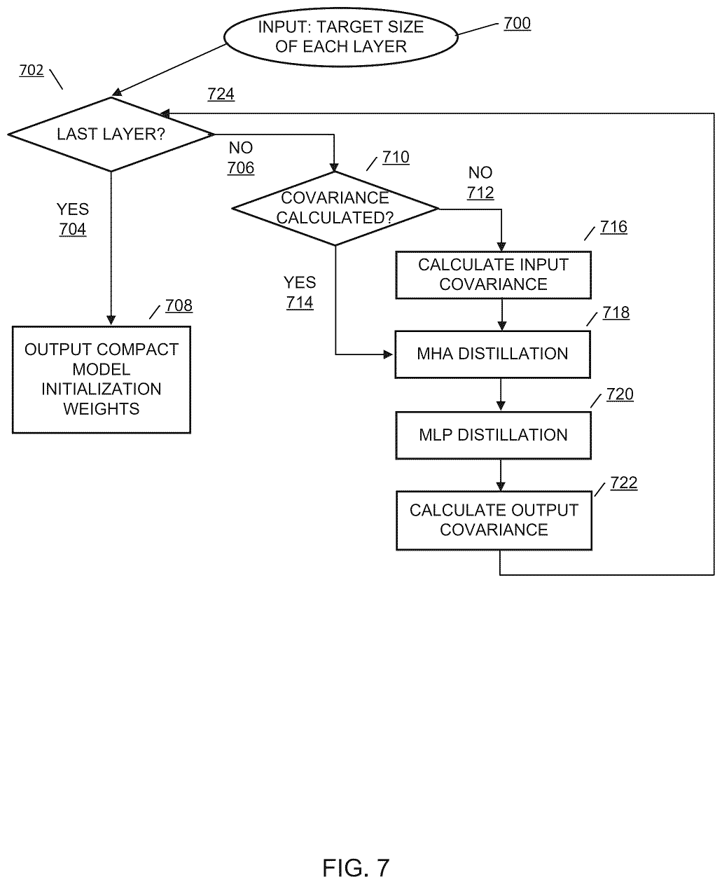

FIG. 7 illustrates a set of operations in accordance with an embodiment of the disclosure. In an embodiment, the operations illustrated in FIG. 7 may be sub-operations of operation 604 in FIG. 6, but not limited thereto. For example, one or more operations illustrated in FIG. 7 may be perform prior to or subsequent to operation 604 in FIG. 6. In an embodiment, the set (or any combination) of operations in FIG. 7 may be implemented in computer codes or instructions stored in the memory 130 and may be performed by the processor 120 of the electronic device 101 (shown in FIG. 1).

At operation 700, a target size of each layer is received as input. At operation 702, it is determined whether a particular layer of the general purpose model is the last layer. If ‘No’ (706), at operation 710, it is determined whether covariance is calculated.

If the covariance is not calculated (No, 712), input covariance is calculated (716); based on the calculated input covariance (from 714 or 716), MHA distillation is performed (718), MLP distillation is performed (720), and an output covariance is calculated (722). Those operations to obtain the calculated output covariance are repeated per each layer. When the particular layer is the last layer (Yes, 704), based on the calculated output covariance, compact model initialization weights are output (708).

In an embodiment, descriptions of the data flow diagram described above with reference to FIG. 7 may be omitted for the sake of brevity. In an embodiment, descriptions of the data flow diagram described above with reference to FIG. 7 may be used to implement at least a portion of at least one of the example application of the first electronic device 101 and may include additional feature.

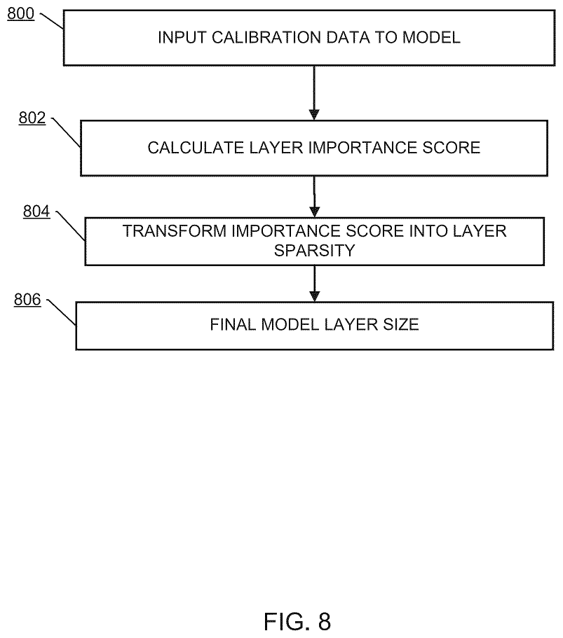

FIG. 8 illustrates a set of operations in accordance with an embodiment of the disclosure. In an embodiment, the set of operations illustrated in FIG. 8 may be performed for transforming scores into layer sizes of the compact model. In an embodiment, the set (or any combination) of operations in FIG. 8 may be implemented in computer codes or instructions stored in the memory 130 and may be performed by the processor 120 of the electronic device 101 (shown in FIG. 1).

At operation 800, the electronic device 101 provides calibration data as input to the model, for example, the dual KD model synthesizer 500 implemented in the electronic device 101. For example, the calibration data is subsample calibration data from common text dataset obtained from public domains (e.g., Wikitext).

At operation 802, the electronic device 101 or the model (e.g., the dual KD model synthesizer 500) calculates the layer importance score. For example, a block influence score is used to measure the layer importance:

$$s = 1 - 𝔼 {x}_{in}^{⊤} {x}_{out} / {‖ {x}_{in} ‖}_{2} {‖ {x}_{out} ‖}_{2} .$$

At operation 804, the electronic device 101 or the model transforms the importance score into layer sparsity. That is, the model receives the layer importance score sᵢ and outputs the layer sparsity ϕᵢ by using the following optimization problem:

$${max}_{{ϕ}_{1 : L}} {\sum }_{i = 1}^{L} {s}_{i} ( 1 - {ϕ}_{i} ) + ε H ( {ϕ}_{i} ) such that \frac{1}{L} {\sum }_{i = 1}^{L} {ϕ}_{i} = {ϕ}_{avg} , 0 \leq {ϕ}_{i} \leq 1 ,$$

At operation 806, the electronic device 101 or the model outputs a layer size of the model, for example, latent dimensions for each layer=[235, 247, 467, . . . ].

In an embodiment, descriptions of the data flow diagram described above with reference to FIG. 8 may be omitted for the sake of brevity. In an embodiment, descriptions of the data flow diagram described above with reference to FIG. 8 may be used to implement at least a portion of at least one of the example application of the first electronic device 101 and may include additional feature.

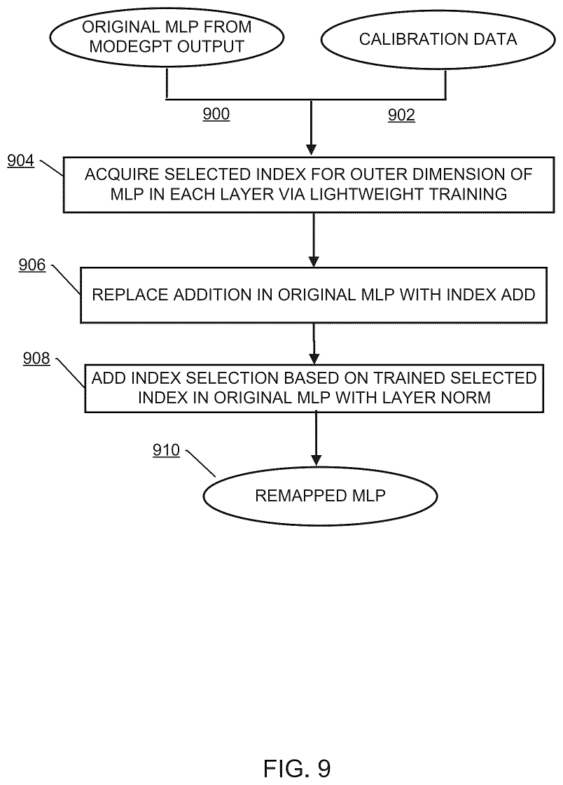

FIG. 9 illustrates a set of operations in accordance with an embodiment of the disclosure. In an embodiment, the set of operations illustrated in FIG. 9 may be sub-operations of operation 610 of FIG. 6, but not limited thereto. For example, one or more operations illustrated in FIG. 9 may be perform prior to or subsequent to operation 610 in FIG. 6. In an embodiment, the set (or any combination) of operations in FIG. 9 may be implemented in computer codes or instructions stored in the memory 130 and may be performed by the processor 120 of the electronic device 101 (shown in FIG. 1).

At operation 900, an original MLP from the dual knowledge distillation model synthesizer (e.g., the dual knowledge distillation model synthesizer 500) is acquired or prepared.

At operation 902, calibration data is acquired or prepared.

At operation 904, via lightweight training, selected index for an outer dimension of MLP in each layer is acquired.

At operation 906, an addition in the original MLP is replaced with index add.

At operation 908, index selection (based on the trained selected index) and layer norm are added in the original MLP, and thus, a remapped MLP is acquired at operation 910.

In an embodiment, descriptions of the data flow diagram described above with reference to FIG. 9 may be omitted for the sake of brevity. In an embodiment, descriptions of the data flow diagram described above with reference to FIG. 9 may be used to implement at least a portion of at least one of the example application of the first electronic device 101 and may include additional feature.

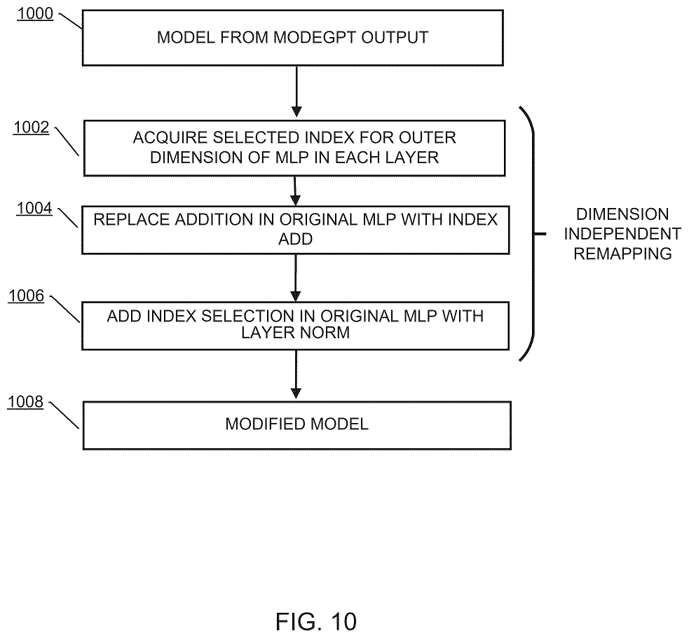

FIG. 10 illustrates a set of operations in accordance with an embodiment of the disclosure. In an embodiment, the set (or any combination) of operations in FIG. 10 may be implemented in computer codes or instructions stored in the memory 130 and may be performed by the processor 120 of the electronic device 101 (shown in FIG. 1). In an embodiment, the set of operation in FIG. 10 may correspond to operation 610 shown in FIG. 6.

At operation 1000, a model of the dual knowledge distillation model synthesizer (e.g., the dual knowledge distillation model synthesizer 500) is acquired.

At operation 1002, selected index for outer dimension of MLP in each layer is acquired. In an embodiment, inputs of operation 1002 may be MLP weights and calibration data. The binary mask s is modeled by the hypernetwork following by a gradient estimator, ReinMax:

$$s = ReinMax ( HyperNetwork ( Θ ) )$$

HyperNetwork may use a method of learning to jointly share and prune weights (e.g., Learning to Jointly Share and Prune Weights for Grounding Based Vision and Language Models, ICLR 2023) and may be trained with the regularized language modeling loss:

$${min}_{⊖} ℒ ( χ ; W , s ) + λℛ ( T ( s ) , {pT}_{total} ) , ℛ ( T ( s ) , {pT}_{total} ) = log ( max ( T ( s ) , {pT}_{total} ) / min ( T ( s ) , {pT}_{total} ) ) .$$

Outputs of operation 1002 may be selected indices for each MLP layer, for example, [[0, 2, 56, 127, . . . ], [4, 78, 321, . . . ],].

At operation 1004, addition in the original MLP is replaced with index add (for example, torch.Tensor.index_add_in PyTorch). Inputs of operation 1004 may be a MLP architecture. Outputs of operation 1004 may be a modified MLP architecture.

At operation 1006, index selection and layer norm are added in the original MLP. Inputs of operation 1006 may be a MLP architecture. Index selection operation (selecting the trained indices in a previous block, for example, torch.index_select in PyTorch) is added to the layer norm. Outputs of operation 1006 may be a modified MLP architecture. Then, at operation 1008, a modified model is acquired.

In an embodiment, descriptions of the data flow diagram described above with reference to FIG. 10 may be omitted for the sake of brevity. In an embodiment, descriptions of the data flow diagram described above with reference to FIG. 10 may be used to implement at least a portion of at least one of the example application of the first electronic device 101 and may include additional feature.

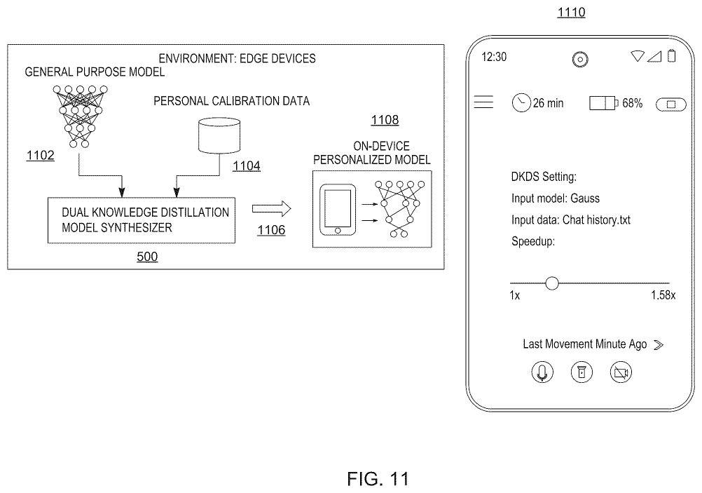

FIG. 11 illustrates use cases in accordance with an embodiment of the disclosure. In an embodiment, the dual knowledge distillation model synthesizer 500 is implemented in edge devices that may correspond to the first electronic device 101, the second electronic device 102, the third electronic device 104, or the server 108.

At operation 1102, the dual knowledge distillation model synthesizer 500 receives a general purpose model (e.g., ‘Gauss’ displayed on the user's device 1110) and a personal calibration data (e.g., ‘Chat history.txt’ displayed on the user's device 1110). A user's device 1110 may correspond to the first electronic device 101, the second electronic device 102, or the third electronic device 104. A user interface of the user's device 1110 shows that an example of the general purpose model is “Gauss” and an example of the personal calibration data is “Chat history.txt”.

At operation 1108, based on the input data (the general purpose model and the personal calibration data), the dual knowledge distillation model synthesizer 500 generates an on-device personal model, which may be implemented in the user's device 1110.

In an embodiment, the dual knowledge distillation model synthesizer 500 may be pre-installed in the user's device 1110. Thus, the user's device 1110 receives the input data and generates the on-device personalized model using the pre-installed dual knowledge distillation model synthesizer 500. In an embodiment, the dual knowledge distillation model synthesizer 500 may be implemented in an external device (such as the second electronic device 102, the third electronic device 104, or the server 108). Then, the on-device personalized model is created in the external device and is transferred to the user's device 1110, for example, via a downloading process.

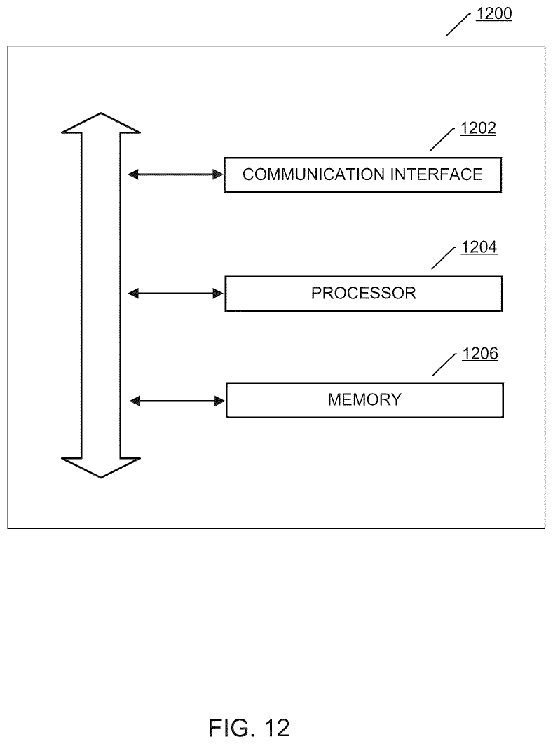

FIG. 12 is an example block diagram of a server 1200 in accordance with an embodiment of the disclosure. The server 1200 may correspond to the server 108 of FIG. 1. In FIG. 12, the server 1200 according to an embodiment of the disclosure may be an electronic device including a communication interface 1202, a processor 1204, and a memory 1206. However, the components of the server 1200 are not limited to the above-described examples. The server 1200 may include more or fewer components than the aforementioned components. According to an embodiment of the disclosure, some or all of the communication interface 1202, the processor 1204, and the memory 1206 may be implemented as a single chip, and the processor 1204 may include one or more processors.

The communication interface 1202 is a component for transmitting and receiving signals (e.g., control commands and data) with an external device (e.g., the electronic device 101) by wire or wirelessly, and may be configured to include a communication chipset that supports various communication protocols. The communication interface 1202 may receive a signal from an external source and output the signal to the processor 1204, or may transmit a signal output by the processor 1204 to an external source. According to an embodiment of the disclosure, referring to FIG. 1, the communication interface 11 may perform communication with the electronic device 101 through the second network 199. In an embodiment, the server 1200 may generate a compact model (e.g., the task specified compact model 506 or a personalized model) using the dual knowledge distillation model synthesizer (e.g., the dual KD model synthesizer 500), and transfer the compact model to the electronic device 101 via the communication interface 1202.

The processor 1204 is configured to control a series of processes so that the server 1200 performs any combination of operations in accordance with embodiments described above. The processor 1204 may include one or a plurality of processors, each comprising processing circuitry. The one or plurality of processors may be a general-purpose processor such as a CPU, an AP, a DSP; a graphics-only processor such as a GPU or a vision processing unit (VPU); or an Artificial Intelligence (AI)-only processor such as a NPU.

For example, when the one or plurality of processors are AI-only processors, the AI-only processors may be designed in a hardware structure specialized for processing a specific AI model. In an embodiment, the processor 1204 may be implemented in a manner similar to that of the processor 120 in FIG. 1.

The processor 1204 may write data to the memory 1206 or read data stored in the memory 1206, and, in particular, may execute one or more programs or one or more instructions stored in the memory 1206 to process data according to a predefined operation rule or an AI model. Accordingly, the processor 1204 may perform any combination of operations described in the above embodiments. Any combination of operations described as being performed by the server 108 in the above embodiments may be considered as being performed by the processor 1204 unless otherwise specified.

According to an embodiment of the disclosure, the memory 1206 may store one or more instructions associated with the operations of the dual KD model synthesizer 500 of FIG. 5. The processor 1204 may execute the one more instructions, causing the server 1200 to implement the task specified compact model 506 and deploy the task specified compact model 502 to the electronic device 101. For example, the one or more instructions, when executed by the processor 1204, may cause the server 1200 to perform at least one of operations described referring to FIGS. 1 to 11. In an embodiment, the server 1200 may comprises a plurality of processors, and the one or more instructions stored in the memory 1206 may be executed by the plurality of processors individually or collectively, causing the server 1200 to perform any combination of operations described above.

The memory 1206, which is a component for storing various programs or data, may be composed of one or more storage medium, such as ROM, RAM, hard disks, CD-ROM, and DVDs, a floppy disk, a cartridge, a magnetic tape, or another type of non-transitory computer-readable medium, along with a corresponding drive. The memory 1206 may not exist separately but may be included in the processor 1204. The memory 1206 may be implemented as a volatile memory, a non-volatile memory, or a combination of a volatile memory and a non-volatile memory. In an embodiment, the memory 1206 may be implemented in a manner similar to that of the memory 130 in FIG. 1.

The memory 1206 may store one or more programs, program codes, or instructions for performing any combinations of operations according to embodiments of the disclosure describe above. The memory 1206 may provide stored data to the processor 1204, in response to a request by the processor 1204. According to an embodiment of the disclosure, a program for generating the task specified compact model 506 may be stored in the memory 1206. According to an embodiment of the disclosure, the dual KD model synthesizer 500 may be stored in the memory 1206.

According to an embodiment of the disclosure, a computer-implemented method may be performed by the server 1200. The method may comprise receiving, via a user interface of the electronic device, a calibration dataset corresponding to a task relevant to a user of an electronic device (e.g., an electronic device 101). The method may comprise providing the calibration dataset as an input to a trained teacher model and an on-device model that are stored in the server. The method may comprise updating the on-device model by, for each layer of the on-device model, determining covariances between the trained teacher model and the on-device model, and modifying the weights for the on-device model using matrix decomposition on weight matrices in the trained teacher model based on the determined covariances. The determining covariances between the trained teacher model and the on-device model may be based on differences between feature maps generated by the trained teacher model and the on-device model, and differences between weights in the trained teacher model and weights in the on-device model. The method may comprises deploying the on-device model to the electronic device. The on-device model deployed on the electronic device may be configured to obtain, via the user interface of the electronic device, first input data from the user. The on-device model deployed on the electronic device may be configured to generate a first output data based on the first input data. The on-device model deployed on the electronic device may be configured to providing the first output data to the user via the user interface of the electronic device.

Alternatively or additionally, the trained teacher model may be a transformer model. In an embodiment, a first matrix decomposition method may be used for a key matrix and a query matrix. A second matrix decomposition method may be used for a value matrix and an output matrix. A third matrix decomposition method may be used for a multi-layer perceptron (MLP) layer. Alternatively or additionally, the first matrix decomposition method may be CR decomposition. The second matrix decomposition method may be singular value decomposition. The third matrix decomposition method may be Nystrom approximation. Alternatively or additionally, sizes of the layers in the on-device model may be calculated based on influence of the layers determined from an input to the layer and an output of the layer.

Alternatively or additionally, the method may comprise obtaining, from the electronic device, a desired model inference speed. The method may comprise determining sizes of the layers in the on-device model based on the desired model inference speed. The method may comprise updating the on-device model with the determined sizes of the layers. The method may comprise deploying the updated on-device model to the electronic device. The updated on-device model with the determined sizes of the layers which is deployed on the electronic device may be configured to obtain, via the user interface of the electronic device, second input data from the user. The updated on-device model with the determined sizes of the layers which is deployed on the electronic device may be configured to generate a second output data based on the second input data. The second output data may be provided to the user via the user interface of the electronic device.

One or more embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store, or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

According to one or more embodiments, in a non-volatile storage medium storing instructions, the instructions may be configured to, when executed by at least one processor, cause the at least one processor to perform at least one operation. The at least one operation may include displaying an application screen of a running application on a display, identifying a data input field included in the application screen, identifying a data type corresponding to the data input field, displaying at least one external electronic device, around the electronic device, capable of providing data corresponding to the identified data type, receiving data corresponding to the identified data type from an external electronic device selected from among the at least one external electronic device through a communication circuit, and entering the received data into the data input field.

The embodiments of the disclosure described in the present specification and the drawings are only presented as specific examples to easily explain the technical content according to the embodiments of the disclosure and help understanding of the embodiments of the disclosure, not intended to limit the scope of the embodiments of the disclosure. Therefore, the scope of one or more embodiments of the disclosure should be construed as encompassing all changes or modifications derived from the technical spirit of one or more embodiments of the disclosure in addition to the embodiments disclosed herein.

What is claimed is:

1. A computer-implemented method performed by an electronic device, comprising:
receiving, via a user interface of the electronic device, a calibration dataset corresponding to a task relevant to a user;
providing the calibration dataset as an input to a trained teacher model and an on-device model that are stored in the electronic device;
updating the on-device model by, for each layer of the on-device model;
determining covariances between the trained teacher model and the on-device model based on:
differences between feature maps generated by the trained teacher model and the on-device model, and
differences between weights in the trained teacher model and weights in the on-device model; and
modifying the weights for the on-device model using matrix decomposition on weight matrices in the trained teacher model based on the determined covariances;
receiving, via the user interface of the electronic device, first input data from the user;
providing the first input data to the updated on-device model;
generating a first output data by the updated on-device model based on the first input data; and
providing the first output data to the user via the user interface of the electronic device.

2. The computer-implemented method of claim 1, wherein the trained teacher model is a transformer model.

3. The computer-implemented method of claim 2, wherein a first matrix decomposition method is used for a key matrix and a query matrix,
wherein a second matrix decomposition method is used for a value matrix and an output matrix, and
wherein a third matrix decomposition method is used for a multi-layer perceptron (MLP) layer.

4. The computer-implemented method of claim 3, wherein the first matrix decomposition method is CR decomposition, the second matrix decomposition method is singular value decomposition, and the third matrix decomposition method is Nystrom approximation.

5. The computer-implemented method of claim 1, wherein sizes of the layers in the on-device model is calculated based on influence of the layers determined from an input to the layer and an output of the layer.

6. The computer-implemented method of claim 1, further comprising:
receiving, from the user via the user interface of the electronic device, a desired model inference speed;
determining sizes of the layers in the on-device model based on the desired model inference speed;
updating the on-device model with the determined sizes of the layers;
receiving, via the user interface of the electronic device, second input data from the user;
providing the second input data to the updated on-device model with the determined sizes of the layers;
generating a second output data by the updated on-device model with the determined sizes of the layers, based on the second input data; and
providing the second output data to the user via the user interface of the electronic device.

7. The computer-implemented method of claim 1, further comprising selecting important features in multi-layer perceptron (MLP) layers of the on-device model based on the calibration dataset prior to deploying the on-device model on the electronic device.

8. A computer-implemented method performed by a server, comprising:
receiving, via a user interface of the electronic device, a calibration dataset corresponding to a task relevant to a user of an electronic device;
providing the calibration dataset as an input to a trained teacher model and an on-device model that are stored in the server;
updating the on-device model by, for each layer of the on-device model;
determining covariances between the trained teacher model and the on-device model based on: differences between feature maps generated by the trained teacher model and the on-device model, and differences between weights in the trained teacher model and weights in the on-device model; and
modifying the weights for the on-device model using matrix decomposition on weight matrices in the trained teacher model based on the determined covariances; and
deploying the on-device model to the electronic device,
wherein the on-device model deployed on the electronic device is configured to:
obtain, via the user interface of the electronic device, first input data from the user; and
generate a first output data based on the first input data, and
wherein the first output data is provided to the user via the user interface of the electronic device.

9. The computer-implemented method of claim 8, wherein the trained teacher model is a transformer model.

10. The computer-implemented method of claim 9, wherein a first matrix decomposition method is used for a key matrix and a query matrix,
wherein a second matrix decomposition method is used for a value matrix and an output matrix, and
wherein a third matrix decomposition method is used for a multi-layer perceptron (MLP) layer.

11. The computer-implemented method of claim 10, wherein the first matrix decomposition method is CR decomposition, the second matrix decomposition method is singular value decomposition, and the third matrix decomposition method is Nystrom approximation.

12. The computer-implemented method of claim 8, wherein sizes of the layers in the on-device model is calculated based on influence of the layers determined from an input to the layer and an output of the layer.

13. The computer-implemented method of claim 8, further comprising:
obtaining, from the electronic device, a desired model inference speed;
determining sizes of the layers in the on-device model based on the desired model inference speed;
updating the on-device model with the determined sizes of the layers;
deploying the updated on-device model to the electronic device,
wherein the updated on-device model with the determined sizes of the layers which is deployed on the electronic device is configured to:
obtain, via the user interface of the electronic device, second input data from the user; and
generate a second output data based on the second input data, and
wherein the second output data is provided to the user via the user interface of the electronic device.

14. The computer-implemented method of claim 8, further comprising selecting important features in multi-layer perceptron (MLP) layers of the on-device model based on the calibration dataset prior to deploying the on-device model on the electronic device.

15. An electronic device comprising:
a user interface;
one or more processors;
a memory storing instructions that, when executed by the one or more processors individually or collectively, cause the electronic device to:
receive, via the user interface, a calibration dataset corresponding to a task relevant to a user;
provide the calibration dataset as an input to a trained teacher model and an on-device model that are stored in the electronic device;
update the on-device model by, for each layer of the on-device model;
determining covariances between the trained teacher model and the on-device model based on: differences between feature maps generated by the trained teacher model and the on-device model, and differences between weights in the trained teacher model and weights in the on-device model; and
modifying the weights for the on-device model using matrix decomposition on weight matrices in the trained teacher model based on the determined covariances;
receive, via the user interface, first input data from the user;
provide the first input data to the updated on-device model;
generate a first output data by the updated on-device model based on the first input data; and
provide the first output data to the user via the user interface of the electronic device.

16. The electronic device of claim 15, wherein the trained teacher model is a transformer model.

17. The electronic device of claim 16, wherein a first matrix decomposition method is used for a key matrix and a query matrix,
wherein a second matrix decomposition method is used for a value matrix and an output matrix, and
wherein a third matrix decomposition method is used for a multi-layer perceptron (MLP) layer.

18. The electronic device of claim 17, wherein the first matrix decomposition method is CR decomposition, the second matrix decomposition method is singular value decomposition, and the third matrix decomposition method is Nystrom approximation.

19. The electronic device of claim 15, wherein sizes of the layers in the on-device model is calculated based on influence of the layers determined from an input to the layer and an output of the layer.
